(19) United States
(12) Patent Application Publication
(10) Pub. No.: US 2002/0096004 A1
(43) Pub. Date: Jul. 25, 2002

(54) Centrifugal force generator and converter

(76) Inventor: Stanley Gagner, North Bergen, NJ (US)

Correspondence Address: EZRA SUTTON, P.A., Plaza 9, 900 Route 9, Woodbridge, NJ, 07095, US

(21) Appl. No.: 09/769,614

(22) Filed: Jan. 24, 2001

(51) Int. Cl. F16H 33/20

(52) U.S. Cl. 74/84 S

(57) ABSTRACT

A centrifugal force generator and converter device for increasing or decreasing the thrust of a moving vehicle, in either of an acceleration mode or in a deceleration mode. The centrifugal force generator and converter device includes an engine housing for receiving a thrust assembly having a retaining ring with an inner perimeter rim surface thereon; a plurality of weight roller assemblies; and a center drive hub assembly for rotating and driving the plurality of weight roller assemblies relative to the inner perimeter rim surface of the retaining ring for creating a centrifugal force. The centrifugal force generator and converter device also includes a power transfer shifter having a horizontal shaft and a vertical shaft; and a power drive train for rotating the horizontal shaft in a first direction and for rotating the vertical shaft in a second direction through the operational use of the power transfer shifter. The vertical shaft is connected to and for moving the center drive hub assembly in a forward or reverse direction. The centrifugal force generator and converter device further includes a slide assembly connected to the power transfer shifter, and to the engine housing; and the slide assembly being movable relative to the engine housing. Additionally, the centrifugal force generator and converter device includes a hydraulic system and a linkage assembly connected to the slide assembly for moving the slide assembly, the vertical shaft, and the thrust assembly in a forward or reverse direction to build up centrifugal force in the engine housing to move the vehicle in a forward or reverse direction.

### FIELD OF THE INVENTION

The present invention relates to a centrifugal force generator and converter device for increasing or decreasing the thrust or momentum of a moving vehicle, in either an acceleration or deceleration mode, without a direct connection to the vehicle's drive train. More particularly, this centrifugal force generator and converter includes a rotatable thrust wheel within a strengthened housing for the spinning (at all of the time) of the rotatable thrust wheel, such that when the driver presses down on the accelerator pedal of the vehicle, the rotatable thrust wheel provides a thrust via the centrifugal force of the thrust wheel, thus throwing the thrust wheel forward in the converter slot for transferring its momentum to moving the vehicle.

### BACKGROUND OF THE INVENTION

Centrifugal force generators and converters (centrifugal thrust motors) are well known in the art. These centrifugal force generator devices use the energy of rotating masses (weights) for conversion into a force in a direction transverse to the axis of the rotating weights.

Typically, a propulsion system that produces a centrifugal force by superimposing a mass (weight) on a rotating member at a predetermined distance radially from the center of rotation of the rotating member to cause an unbalanced condition on the member resulting in a centrifugal force being generated in the rotating member. To fully understand the physical principles surrounding this centrifugal force generator system, an examination of the mathematical equations used to calculate this centrifugal force and propulsion force are as follows:

F=W(ω)²R/G (I)

Fₚ=F−F′ (II)

where,

F=Centrifugal Force

F′=Reaction Force

R=Radius

Fₚ=Propulsion Force

W=Weight of Out of Balance

ω=Angular Velocity

G=Acceleration Due to Gravity

In examining equation (I), the magnitude of the centrifugal force depends upon the size of the weight that is superimposed on the rotating member, the radius of this weight from the center of rotation and the angular velocity of the rotating member. In accordance with Newton's Third Law of Motion (for every action, there is an equal and opposite reaction), the generation of the centrifugal force caused by the weight being superimposed on the rotating member, a reaction for F′, is produced equal in magnitude to the centrifugal force but acts opposite in direction.

In examining equation (II), when F=F′, this propulsion device will not move. To overcome this difficulty, F−F′ must be greater than 0, and F′ must be less than F. The propulsion device reduces F′ by providing a method of isolating F′, such that the weight is superimposed on the rotating member in order to obtain a large propulsive force, the efficiency of the isolation system to reduce F′ considerably is the controlling factor for an effective centrifugal force generator and converter device.

There are many different types of known propulsion devices which converts centrifugal force into linear force, such that the propulsion device does not need a medium (air, water, roadway) against in which to push for moving the vehicle in one direction. There are several disadvantages with the aforementioned propulsion devices that use the principle of a centrifugal force generator. For example, these devices typically require a number of complex gearing systems, some of which have to be mounted on rotating members. In addition, some of the prior art devices require a plurality of heavy weights which add to the overall weight of the device and require additional reinforcing members in the supporting frame of the device, resulting in increased expense. Such devices are typically large and bulky and would be difficult to mount safely in a small vehicle. At the same time, their large size makes it difficult for them to be positioned to direct the resultant unidirectional force to guide the vehicle within which they are mounted. Further, these devices generate a resultant force that is cyclic thereby inducing vibratory loads within the device.

Accordingly, there remains a need for a centrifugal force generator and converter device which converts rotational forces to a constant unidirectional force which is relatively compact, does not require a plurality of heavy spinning weights, and does not require complex gearing mechanisms. In addition, there is a need for a device in which the constant unidirectional force which is generated can be directed and controlled easily in a forward direction or in a reverse direction.

### DESCRIPTION OF THE PRIOR ART

Centrifugal force generators and converters of various designs, configurations and structures have been disclosed in the prior art. For example, U.S. Pat. No. 1,953,964 to Laskowitz discloses a centrifugal variable thrust mechanism for developing a thrust that may be varied in order to effect the propulsion of the vehicle. The centrifugal variable thrust mechanism includes a series of inter-connected weights having means associated therewith whereby the axis of an eccentric member operatively connected to the weights may be shifted to cause the weights to assume different positions and causing the radial distances between the weights and the axis of rotation to vary so that the rotation of the weights will result in different centrifugal forces being set up, thus causing an unbalanced resultant thrust to be set up that will tend to move the mechanism and which resultant thrust may be utilized as the propelling force.

U.S. Pat. No. 3,750,484 to Benjamin discloses a centrifugal thrust motor for use in moving vehicles. The centrifugal thrust motor includes a frame member having a continuous track portion and a rotating shiftable shaft positioned within the track portion. The centrifugal thrust motor further includes a plurality of weight support members each having a working length secured to the shaft, and a drive mechanism provided for rotating the shaft in a direction transverse to the axis of the shaft, whereby the energy of the rotating masses is translated into a force in a direction transverse to the axis of the rotating weights. The force thus generated is suitably controlled and is used to propel a vehicle in a forward or reverse direction.

U.S. Pat. Nos. 3,968,700 and 3,998,107 to Cuff disclose a device for converting rotary motion into a unidirectional linear motion. This device converts the centrifugal forces produced by rotating masses into a propulsive force acting in one direction and which is comprised of a movable support structure in which identical sets of masses rotate in opposite directions about an axis which is perpendicular to the desired direction of travel and a mechanism for continuously varying the radius of gyration of each mass during its cycle of revolution.

U.S. Pat. No. 4,261,212 to Melnick discloses a unidirectional force generator for propelling a vehicle in one given direction. This device uses a centrifugal force generator which repetitively provides alternately occurring prolonged centrifugal forces of opposite direction along a line fixed relative to the generator. As these forces are produced the generator is turned relative to a support carriage so that each time such a force occurs, it has a generally forward direction relative to the carriage. Two or more centrifugal force generators may be mounted on a single carriage and operated in synchronism and in proper phase relationship to one another to produce a forwardly directed force of relatively stead magnitude and/or to cancel force components directed perpendicular to the forward direction.

U.S. Pat. No. 4,479,396 to de Weaver, III discloses a propulsion system for converting rotary motion into unidirectional motion. This invention encompasses a propulsion system that produces a centrifugal force by superimposing a mass (weight) on a rotating member at a predetermined distance radially from the center of rotation of the member to cause an unbalanced condition on the member resulting in a centrifugal force being generated in the member. The propulsion system includes a frame, a pair or counterrotating lower members rotatably mounted to the frame and containing damping elements, a pair of upper members containing damping elements and rotatably mounted to the frame and positioned above the lower members, each at an angle to the lower member so that each contacts a surface of the member below it at a single point, and a motor and drive train for driving the lower members. The superposition of the damped upper members upon the damped lower members generates unbalanced centrifugal forces which create a constant unidirectional resultant force.

U.S. Pat. No. 4,884,465 to Zachystal discloses a device for obtaining a directional force from a rotary motion. This device has a frame rotating about a longitudinal axis at a selected angular speed. A weight is connected to the frame and rotates about a transverse axis at the same angular speed. When the weight has transversed 180°, the frame itself will have rotated through 180°, so that the weight will return to its original position on the same side of the apparatus as it transversed in the first half cycle. The resultant centrifugal forces all act to one side of the apparatus, producing a unidirectional thrust.

U.S. Pat. No. 5,488,877 to Lieurance discloses a centrifugal inertia drive device. This device produces a force vector with magnitude and direction. This force is produced by two interconnected masses in rotation where the radius of each mass, from the center of rotation, varies equally but in opposite directions. This action produces two independent centrifugal forces that pull both masses outward from the center of rotation at different force magnitudes. This imbalance in centrifugal force between the two masses as they rotate through the centrifugal inertia drive cycle creates a force vector. The two mass systems can be combined in multiples to create larger and more unified vectored forces.

U.S. Pat. No. 5,890,400 to Oades discloses an apparatus for generating a propulsion force in a predetermined direction. The apparatus includes an outer frame and an inner frame slidably mounted within the outer frame. The inner frame supports a flywheel which rotates about a shaft defining a first axis. Masses are mounted to the flywheel for rotational movement with the flywheel and for lateral movement relative to the flywheel in a direction to increase and decrease a distance of a center of gravity of the masses from the first axis. The outer frame supports a mass movement control member rotating with the flywheel about a second axis parallel to the first axis. The control member moves the masses cyclically such that the distance from the first axis is at a maximum in the direction of propulsion and a minimum in a direction opposite to the direction of propulsion. A directional control controls the displacement of the outer frame in relation to the inner frame for controlling magnitude and direction of the propulsion force by adjusting the amount of offset between the first and second axes.

U.S. Pat. No. 5,937,698 to Kunz discloses a centrifugal propulsion system, this device includes an eccentric rotor rotatably mounted to a base via a shaft. The rotor has an aperture therein which is substantially larger than the shaft, such that the rotor is able to rotate at speed away from the shaft, as well as move longitudinally perpendicular to the axis of rotation. A drive motor drives the rotor through a stretchable flexible belt. As centrifugal force rotates the rotor toward a longitudinal standing position alone away from the shaft and drive motor, and as the drive belt is stretched, the increased tension therein pulls the drive motor and base ahead following the rotor, thus pulling the device in a desired direction.

None of the prior art patents disclose or teach the design, structure and configuration of the present invention of a centrifugal force generator and converter that is used for moving a vehicle in a forward or reverse direction having no braking devices to stop the momentum of vehicle while in motion. Further, the prior art patents do not disclose or teach the use of a hydraulic system to return the rotatable drive wheel to a neutral position within the generator housing.

Accordingly, it is an object of the present invention to provide an improved centrifugal force generator and converter having means for converting rotational (centrifugal) energy into a unidirectional (translational) energy in order to transfer the thrust or momentum to move a vehicle in a forward direction or in a reverse direction.

Another object of the present invention is to provide a centrifugal force generator and converter for moving a vehicle in a forward direction or in a reverse (opposite) direction having no braking devices needed in order to stop the momentum of the vehicle while in motion.

Another object of the present invention is to provide a centrifugal force generator and converter that is made of durable construction having a minimum of moving parts therein and being relatively compact in size and does not require complex gearing mechanisms.

Another object of the present invention is to provide a centrifugal force generator and converter that generates a unidirectional force that may be changed so that the force is exterted in the desired direction and is easily controlled by the driver/user.

Another object of the present invention is to provide a centrifugal force generator and converter that uses a rotatable drive wheel having a series of weighted rollers about its periphery within a strengthen housing for generating rotational energy to translational energy in which to provide thrust to move a vehicle via the centrifugal force of the rotatable drive wheel.

Another object of the present invention is to provide a centrifugal force generator and converter that is used in conjunction with an internal combustion engine, an electric motor, or other types of engines for moving a vehicle.

Another object of the present invention is to provide a centrifugal force generator and converter that exerts a thrust of 26,200 lbs. of force at full speed.

Another object of the present invention is to provide a centrifugal force generator and converter that uses a hydraulic system to return the rotatable drive wheel to a neutral position within the generator/converter housing.

A further object of the present invention is to provide a centrifugal force generator and converter that is cost efficient and economical in operation having low/minimal maintenance problems when in use.

A still further object of the present invention is to provide a centrifugal force generator and converter that can be mass produced in an automated and economical manner and is readily affordable by the user.

### SUMMARY OF THE INVENTION

In accordance with the present invention, there is provided a centrifugal force generator and converter device for increasing or decreasing the thrust of a moving vehicle, in either of an acceleration mode or in a deceleration mode. The centrifugal force generator and converter device includes an engine housing for receiving a thrust assembly having a retaining ring with an inner perimeter rim surface thereon; a plurality of weight roller assemblies; and a center drive hub assembly for rotating and driving the plurality of weight roller assemblies relative to the inner perimeter rim surface of the retaining ring for creating a centrifugal force.

The centrifugal force generator and converter device also includes, a power transfer shifter having a horizontal shaft and a vertical shaft; and a power drive train for rotating the horizontal shaft in a first direction, and for rotating the vertical shaft in a second shaft in a second direction through the operational use of the power transfer shifter. The vertical shaft is connected to and for moving the center drive hub assembly in a forward or reverse direction.

The centrifugal force generator and converter device further includes a slide assembly connected to the power transfer shifter, and to the engine housing; and the slide assembly being movable relative to the engine housing. Additionally, the centrifugal force generator and converter device includes a hydraulic system and a linkage assembly connected to the slide assembly for moving the slide assembly, the vertical shaft, and the thrust assembly in a forward or reverse direction to build up centrifugal force in the engine housing to move the vehicle in a forward or reverse direction.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a perspective view of the centrifugal force generator and converter of the preferred embodiment of the present invention showing the major component parts in an assembled configuration;

FIG. 2 is an exploded perspective view of the centrifugal force generator and converter of the present invention showing the top cover, the main frame having a hydraulic cylinder, an electric motor, an electric clutch motor and a 90° power transfer shifter thereon, and the bottom cover in a partially assembled configuration;

FIG. 3 is an exploded perspective view of the centrifugal force generator and converter of the present invention, showing the main frame having a plurality of weighted rollers and roller pins, a center drive hub and a centrifugal force retaining ring therein;

FIG. 4 is a perspective view of the centrifugal force generator and converter of the present invention showing the main frame having the four weighted rollers connected to the center drive hub within the centrifugal force retaining ring in an assembled configuration;

FIG. 5 is an enlarged partial perspective view of the centrifugal force generator and convertor of the present invention showing a weighted roller connected to the center drive hub;

FIG. 6 is an elevational view of the centrifugal force generator and converter of the present invention showing the gib ball bearings, the gibs of the slide member assembly, the angle changer element of the 90° power transfer shifter and the top cover.

FIG. 7A is a top plan view of the centrifugal force generator and converter of the present invention showing the slide member assembly and its component parts thereon;

FIG. 7B is an exploded partial perspective view of the centrifugal force generator and converter of the present invention showing the slide member assembly and its component parts;

FIG. 8 is a schematic representation of the centrifugal force generator and converter of the present invention showing the electrical and hydraulic system layout;

FIG. 9 is a schematic representation of the centrifugal force generator and converter of the present invention showing the cooling system layout;

FIG. 10 is a schematic representation of the centrifugal force generator and converter of the present invention showing the power drive train layout including the electric motor, the electric clutch, the ball bearing spline member having shaft adapters thereon, and the 90° power transfer shifter; and

FIG. 11 is a graphic representation of the centrifugal force generator and converter of the present invention showing the pounds of thrust/force versus the rpm's of the electric motor at various motor speeds.

### DETAILED DESCRIPTION OF THE PREFERRED EMBODIMENT OVERVIEW

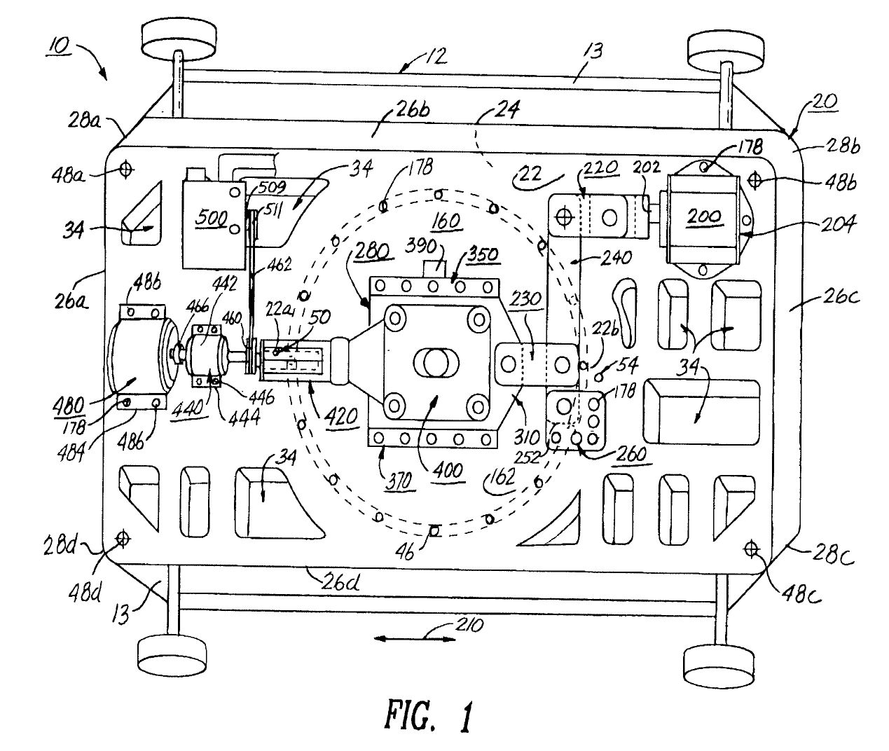

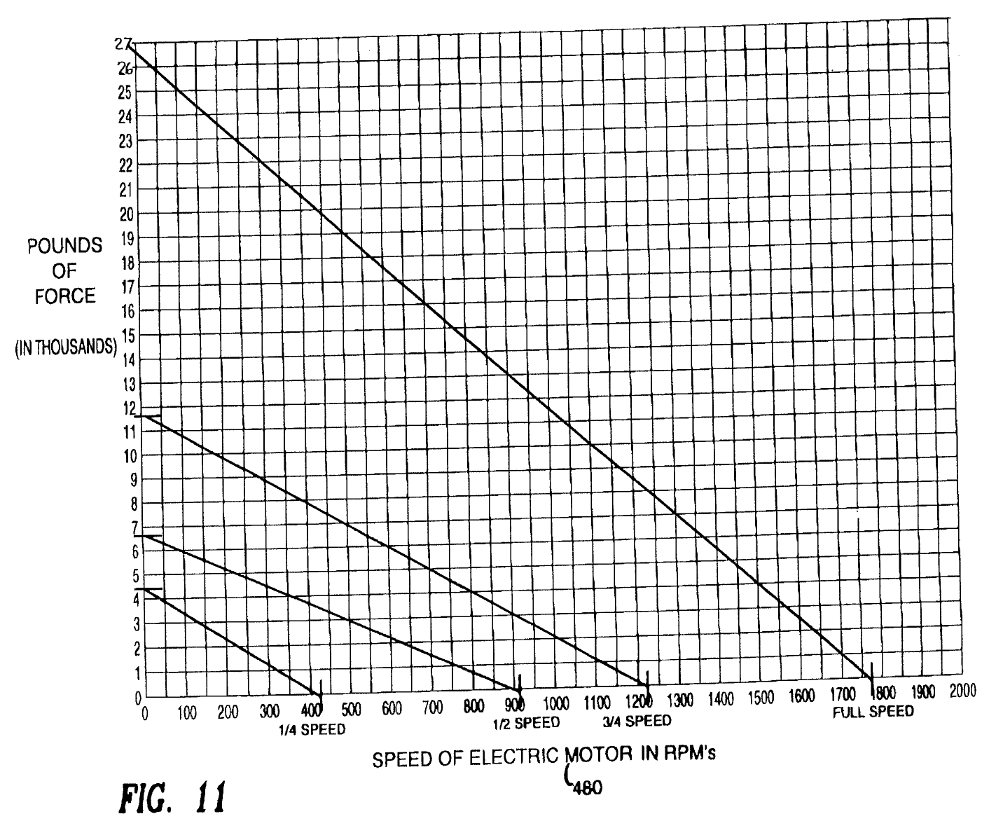

The centrifugal force generator and converter device 10 and its component parts of the preferred embodiment of the present invention are represented in detail by FIGS. 1 through 11 of the patent drawings. The centrifugal force generator and converter device 10 is used for increasing or decreasing the thrust or momentum of a moving vehicle, in either an acceleration or deceleration mode; without a direct connection to the vehicle's drive train. Device 10 has application for moving vehicles such as cars, trucks, vans, boats, ships, aircraft, helicopters and trains. The centrifugal force generator and converter 10 includes a main frame housing 20 having a centrifugal force retaining ring 60, a center drive hub 70 with a plurality of weight roller assemblies 120A, 120B, 120C and 120D attached thereto, a top cover 160 and a bottom cover 180. The centrifugal force generator and converter 10 also includes an hydraulic cylinder device 200, a first and second clevis pins 220 and 230, a lever member 240 and a pivot mounting bracket 260. The centrifugal force generator and converter 10 further includes a slide member assembly 280, a 90° power transfer shifter 400, a ball bearing spline device 420, an electric clutch device 440, an electric motor device 480, and an air pump device 500 having an air molecule splitter member 520 connected thereto. Additionally, the centrifugal force generator and converter 10 also includes an electrical and hydraulic system 600 for providing both power and hydraulic pressure in operating device 10, and a cooling system 700 for cooling the main frame housing 20 and its component parts therein. FIG. 11 is a graphic representation showing the pounds of force (thrust) versus rpm's of the electric motor device 480 at various motor speeds being produced by the operational centrifugal force generator and converter 10 of the present invention.

### Preferred Embodiment 10

The centrifugal force generator and converter device 10, as shown in FIGS. 1 through 5 and 8 of the drawings, includes a moving vehicle 12 having a chassis frame 13, power sources 14, an acceleration pedal 16 and a brake pedal 18. Power sources 14 can be conventional 12 volt car batteries for supplying power to the electrical and hydraulic system 600. The acceleration pedal 16 activates device 10 to start-up via the electronic control unit (CPU) 602, and the control solenoid valve 620, which in turn simultaneously activates the two-way hydraulic cylinder device 200 and the electric motor device 480 to move the vehicle 12 in a forward direction F (←) by the forward thrust of device 10. The brake pedal 18 also activates device 10 to input electronic signals via the electronic control unit (CPU) 602, and the control solenoid valve 620 to decrease its pressure which in turn reverses the movement (thrusting) of device 10 in order to stop the forward motor vehicle 12 or puts the vehicle 12 in a reverse direction R (→). Brake pedal 18 also acts a conventional brake pedal for a conventional braking system (not shown) in order to instantaneously stop the forward movement of vehicle 12. The centrifugal force generator and converter device 10 replaces the need for conventional diesel and gas combustion engines, or electric car motors, as this device 10 would only use a small gas generator (not shown) or an electric motor 480 for use in the increasing or decreasing of thrust of the moving vehicle 12.

### Main Frame Housing 20

The main frame housing 20, as shown in FIGS. 1 through 5 of the drawings, includes an upper top wall surface 22, a bottom rear wall surface 24, side perimeter edges 26a to 26d, side comers 28a to 28d, and a large centrally located hole opening 30 having an inner cylindrical perimeter wall 32 for receiving the centrifugal force retaining ring 60 therein. Inner cylindrical perimeter wall 32 includes a semi-circular (U-shaped) channel opening 33 therein for use as a cooling core opening 64c in which to receive cold air 544 from cooling system 700. Channel opening 33 of perimeter wall 32 is aligned and adjacent to channel opening 64 of perimeter wall surface 62 of retaining ring 60 to form cooling core opening 64c. Main frame housing 20 also includes a plurality of cut-openings 34 of various shapes (square, oval, rectangular, trapezoid, etc.) for reducing the total weight of the main frame housing 20. Main frame housing 20 is made from cast aluminum or cast steel.

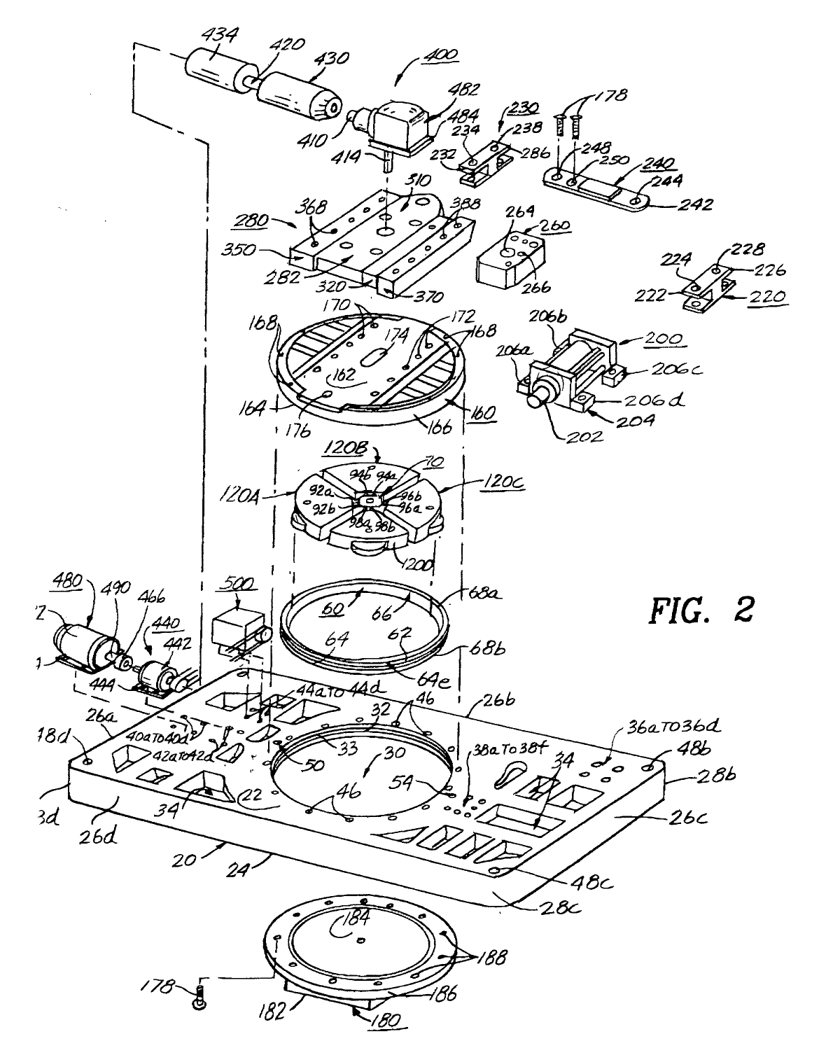

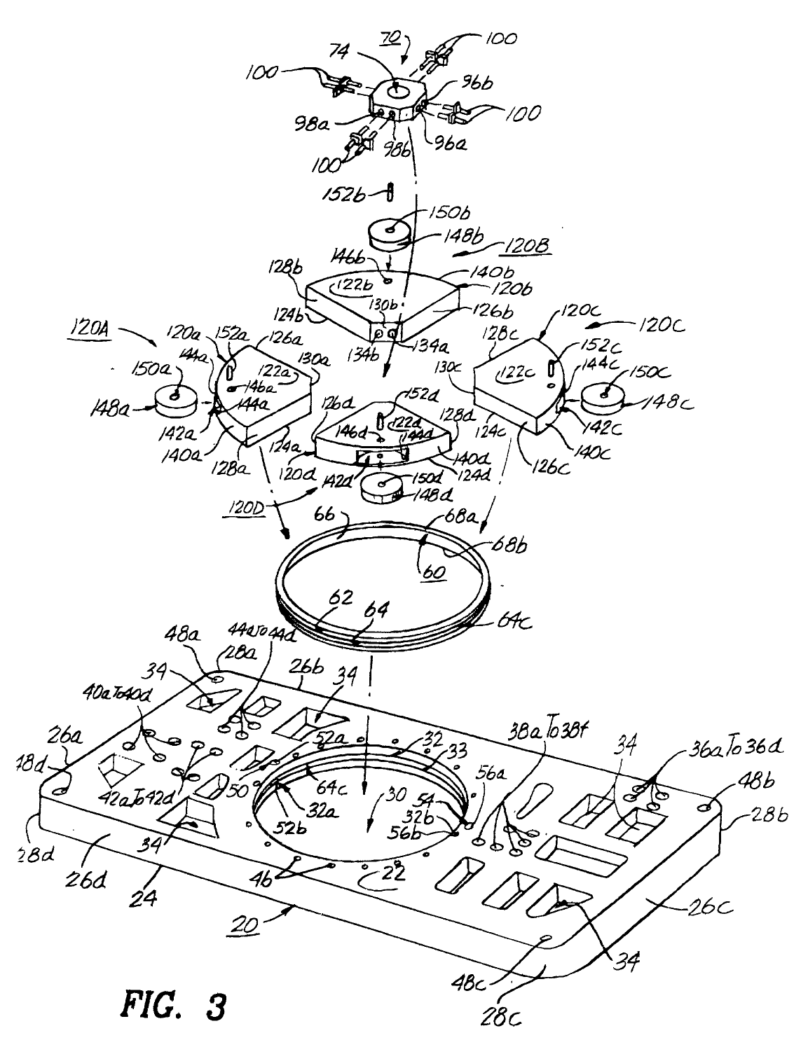

Main frame housing 20 further includes, as shown in FIGS. 2 and 3 of the drawings, a first set of mounting openings 36a to 36d for mounting and attaching the hydraulic cylinder device 200 thereon; a second set of mounting openings 38a to 38e for mounting and attaching the pivot mounting bracket 260 thereon; a third set of mounting openings 40a to 40d for mounting and attaching the electric motor device 480 thereon; a fourth set of mounting openings 42a to 42d for mounting and attaching the electric clutch device 440 thereon; a fifth set of mounting openings 44a to 44d for mounting and attaching the air pump device 500 thereon; a sixth set of mounting openings 46 arranged in a circular configuration for mounting and attaching each of the top and bottom covers 160 and 180, respectively, to the main frame housing 20; and a seventh set of mounting openings 48a to 48d being positioned at each of the frame housing comers 28a to 28d, respectively, for mounting and attaching to the vehicle chassis frame 13 of vehicle 12. The main frame housing 20 is used to house and mount all of the essential and critical component parts thereto, as depicted in FIGS. 1 to 3 of the drawings.

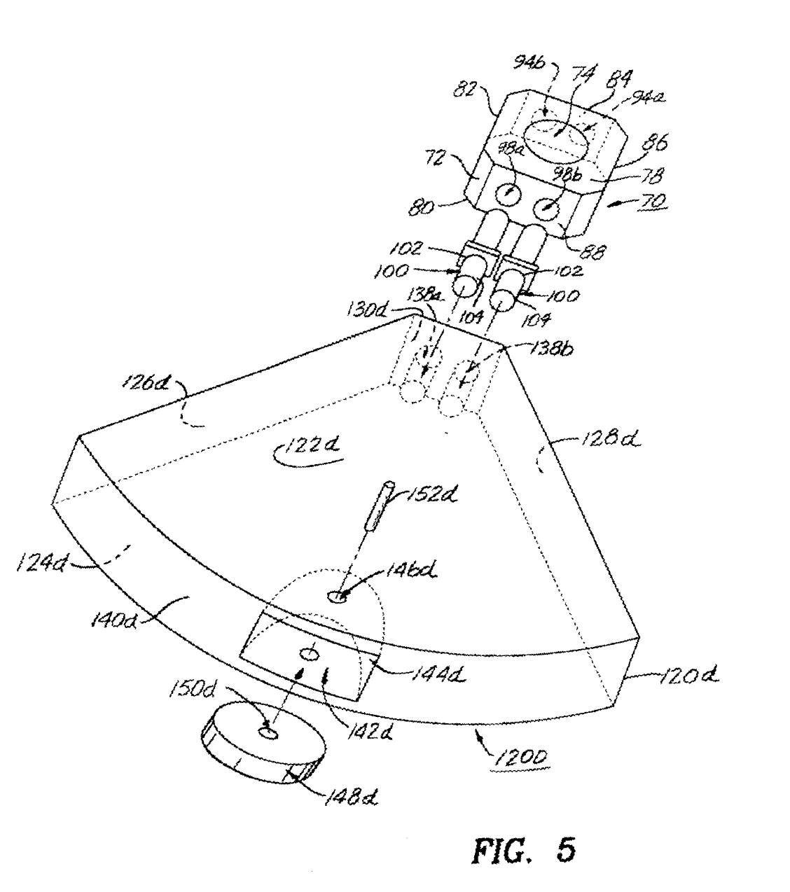

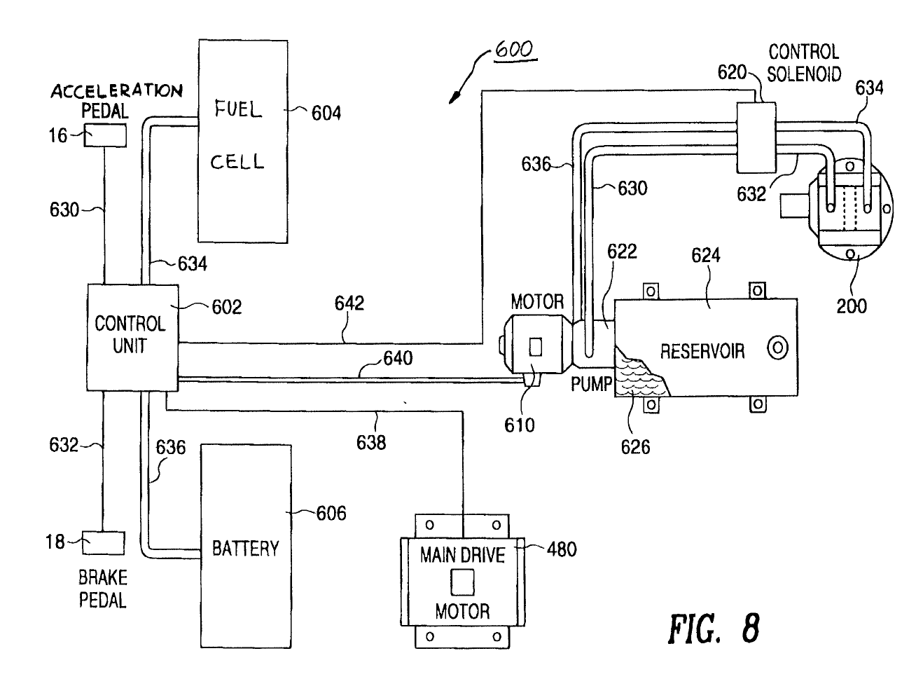

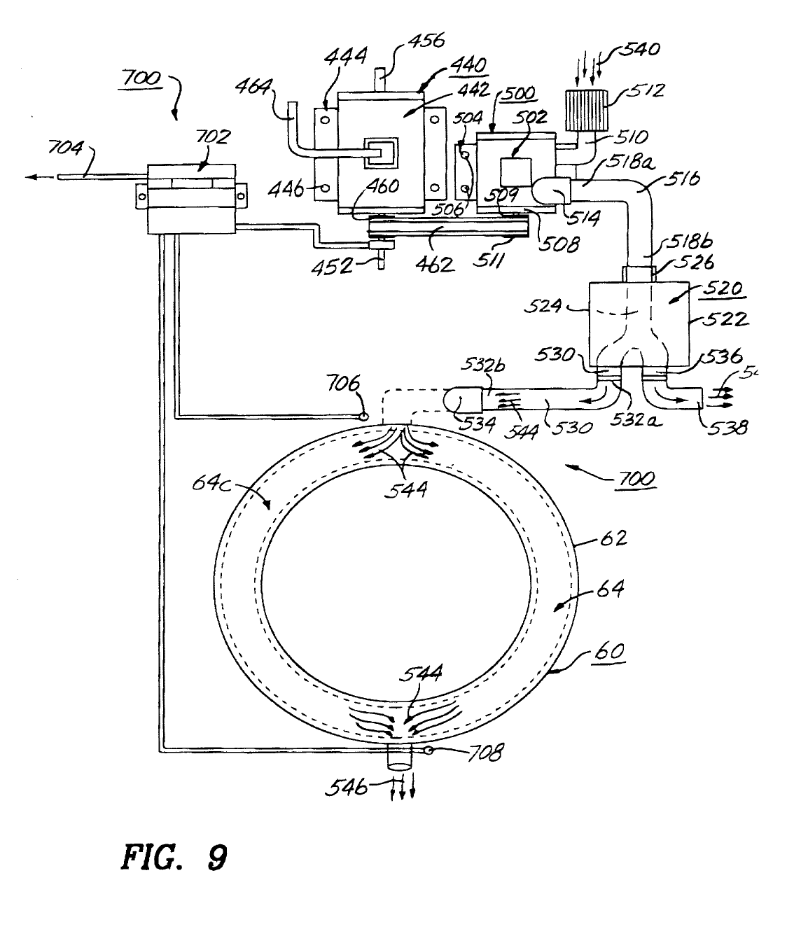

Main frame housing 20 also includes, as shown in FIGS. 5 and 9 of the drawings, an air inlet channel 50 being L-shaped and an air exhaust channel 54 being L-shaped. Air inlet channel 50 includes a first cold air intake opening 52a located on the upper top wall surface 22 at location point 22a, and includes a second cold air outlet opening 52b located on the inner cylindrical perimeter wall 32 at location point 32a. Air exhaust channel 54 includes a first cold air intake opening 56b located on the inner cylindrical perimeter wall 32 at location point 32b and includes a second cold air exhaust opening 56a located on the upper top wall surface 22 at location point 22b. The air inlet channel 50 and the air exhaust channel 54 are diametrically opposed to each other, as depicted in FIGS. 5 and 9. The air inlet channel 50 and the air exhaust channel 54 are used to transfer in and out of cold air 544 in which to cool the centrifugal force retaining ring 60 from over heating during the operational use of device 10 via the cooling system 700, as depicted in FIG. 8 of the drawings.

### Centrifugal Force Retaining Ring 60

The centrifugal force retaining ring 60 includes, as shown in FIGS. 2 and 3 of the drawings, an outer perimeter rim wall surface 62 having a semi-circular (U-shaped) channel opening 64 therein for use as a cooling core opening 64c in which to receive cold air 544 from the cooling system 700. The centrifugal force retaining ring 60 further includes an inner perimeter rim wall surface 66 for contacting with the weight roller pin members 148a to 148d attached to each of the weight roller members 120a to 120d, respectively, and ring perimeter sides 68a and 68b. The centrifugal force retaining ring 60 is made from tooled stainless steel or other alloyed steels for minimum abrasive wear from the contact of the weight roller pin members 148a to 148d. The centrifugal force retaining ring 60 allows for the build-up of the centrifugal force/thrust along the inner perimeter rim wall surface 66 at all times during the operation of device 10.

### Center Drive Hub Assembly 70

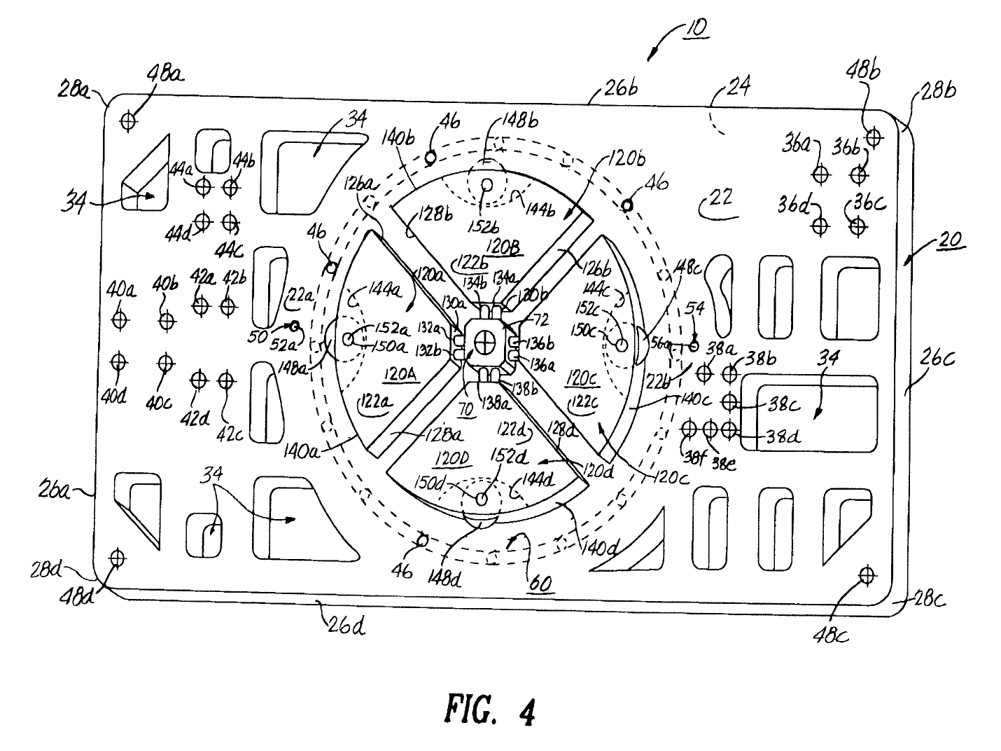

The center drive hub assembly 70 includes, as shown in FIGS. 2 through 5 of the drawings, a hub housing 72 being substantially square-shaped. Hub housing 72 includes a centrally located shaft opening 74 having a keyway channel 76 therein for receiving a keyway bar 118 therethrough, an upper wall surface 78, a bottom wall surface 80, and side wall surfaces 82, 84, 86 and 88. Side wall surface 82 includes a threaded shaft opening 90 being located at the midpoint 82p of side wall surface 82. The threaded shaft opening 90 is used for receiving a set screw 116 for holding the keyway bar 118 in place against the vertical shaft 414 of the 90° power transfer shifter 400. Each of the side wall surfaces 82, 84, 86 and 88 includes a pair of equally spaced-apart of drive hub openings 92a, 92b, 94a, 94b, 96a, 96b, 98a and 98b, respectively, as shown in FIGS. 4 and 5 of the drawings. Each of the drive hub openings 92a, 92b, 94a, 94b, 96a, 96b, 98a and 98b are used to receive a weight support pin 100 therein. Each weight support pin 100 includes a roller bearing or slide bushing 102 being attached to the outer end 104 of the weight support pin 100. The roller bearing or slide bushing 102 enables each of the weight roller members 120a to 120d to laterally move approximately ¼ inch. The center drive hub assembly 70 is made of tooled stainless steel or alloyed steel. The center drive hub assembly 70 is used to hold all of the weight roller members 120a to 120d in a proper and aligned orientation, as well as being used to turn all four of the weight roller members 120a to 120d in order to create the centrifugal force within the centrifugal force retaining ring 60 of device 10.

### Weight Roller Assemblies 120A to 120D

The plurality of weight roller assemblies 120A, 120B, 120C and 120D each include, as shown in FIGS. 2 to 5 of the drawings, a weight roller member 120a to 120d, each being substantially a quarter circular-shaped cylinder configuration. Each of the weight roller 20 members 120a to 120d includes an upper top wall surface 122a to 122d, a bottom wall surface 124a to 124d, a left side wall surface 126a to 126d, a right side wall surface 128a to 128d and an inner side wall surface 130a to 130d, respectively. Each of the inner side wall surfaces 130a to 130d includes a pair of equally spaced-apart weight roller hub openings 132a, 132b, 134a, 134b, 136a, 136b, 138a and 138b, respectively, for receiving the inner end 106 of the weight support pins 100. Each of the weight roller members 120a to 120d further includes an outer curved wall surface 140a to 140d having a weight roller pin cavity section 142a to 142d therein for receiving a weight roller pin member 148 a to 148d therein. Further, each of the weight roller pin cavity sections 142a to 142d includes a pin opening 146a and 146d being located on the upper top and bottom wall surfaces 122a to 122d and 124a to 124d, respectively, and includes an inner curved contact wall surface 144a to 144d, respectively, for contacting and rolling of each of the weight roller pin members 148a to 148d, therein, as depicted in FIGS. 4 and 5 of the drawings. Each of the weight roller pin members 148ato 148d includes a pin hole opening 150ato 150d, respectively, therein. Each of the weight roller pin members 148a to 148d is attached within each of the weight roller pin cavity sections 142a to 142d by a cylindrically-shaped roller pin element 152a to 152d which are received and aligned through each to pin openings 150a to 150d of each weight roller pin members 148a to 148d, and through each bottom pin openings 146b of weight roller members 120a to 120d, respectively.

### Top Cover 160

The top cover 160 includes, as shown in FIGS. 1, 2 and 6 of the drawings, an outer cover wall surface 162, an inner cover wall surface 164 and a perimeter rim edging 166. The top cover 160 also includes a plurality of mounting openings 168 arranged in a circular configuration being adjacent to the perimeter rim edging 166 and are used for attaching the top cover 160 to the main frame housing 20 via bolts 178. The top cover 160 further includes a first set of mounting openings 170 and a second set of mounting openings 172 being parallel with each other for mounting the first and second gib members 350 and 370, respectively, to the top cover 160 via bolts 178. Additionally, top cover 160 also includes a centrally located oval shaft opening 174 for receiving therein the vertical shifter shaft 414 of the 90° power transfer shifter 400, and a second hole opening 176 for receiving an air line 530 thereon. The top cover 160 is made from cast steel or stainless steel materials. The top cover 160 is used for covering the internal component parts 60, 70, and 120A to 120D within the main frame housing 20, as well as for mounting of the first and second gib members 350 and 370 thereon. Additionally, the top cover 160 is also used to retain the shape of the retaining ring 60, as well as contain the forward and reverse thrust within the main frame 20.

### Bottom Cover 180

The bottom cover 180 includes, as shown in FIG. 2 of the drawings, an outer cover wall surface 182, an inner cover wall surface 184 and a perimeter rim edging 186. The bottom cover 180 further includes a plurality of mounting openings 188 arranged in circular configuration being adjacent to the perimeter rim edging 186 and are used for attaching the bottom cover 180 to the main frame housing 20 via bolts 178. The bottom cover 180 is made from cast steel or stainless steel materials. The bottom cover is used for covering the internal component parts 60, 70 and 120A to 120D within the main frame housing 20 of device 10. Additionally, the bottom cover 180 is also used to retain the shape of the retaining ring 60, as well as contain the forward and reverse thrust within the main frame 20.

### Hydraulic Cylinder Device 200

The hydraulic cylinder device 200 includes, as shown in FIGS. 1 and 2 of the drawings, a two way hydraulic piston cylinder member 202, a frame member 204 for holding the piston cylinder member 202 in place and side lug mountings 206a to 206d each having a mounting openings 208a to 208d, respectively, therein for mounting and attaching to the main frame housing 20 via bolts 178. The two way hydraulic cylinder device 200 is used for operating the lever member 240 and the slide member assembly 280 in a lateral motion in order to increase or decrease the thrust or momentum of device 10.

### Clevis Pins 220 and 230

The first clevis pin 220 includes a first attachment end 222 having first attachment openings 224 therein and a second attachment end 226 having second attachment openings 228 therein. The first clevis pin 220 is used for attachment and connecting the hydraulic cylinder device 200 to the lever member 240 via bolts 178 through each of the first and second attachment openings 224 and 228, respectively, as depicted in FIGS. 1 and 2 of the drawings.

The second clevis pin 230 includes a first attachment end 232 having first attachment openings 234 therein and a second attachment 236 having second attachment openings 238 therein. The second clevis pin 230 is used for attachment and connecting the lever member 240 to the second hole opening 312 of the attachment member section 312 of the main slide section 282 via bolts 178 through each of the first and second attachment openings 234 and 238, respectively, as depicted in FIGS. 1 and 2 of the drawings. Both clevis pins 220 and 230 are made from tooled steel or alloyed steel materials.

### Lever Member 240

The lever member 240 includes a first attachment end 242 having a first attachment opening 244 therein and a second attachment end 246 having a second attachment opening 248 therein and having a third attachment opening 250 therein. The first attachment opening 244 of lever member 240 is aligned and placed between the second attachment openings 228 of the first clevis pin 220 and are joined together via bolts 178. The second attachment opening 248 of lever member 240 is aligned and placed between the first attachment openings 234 of the second clevis pin 230 and are joined together via bolts 178. The third attachment opening 250 of lever member is aligned with the first hole opening 264 of the pivot mounting bracket 260 and are joined together by a bolt 178 which allows the pivotal movement of the lever member 240. The third attachment opening 250 of lever member 240 when joined to the first hole opening 264 of pivot mounting bracket 260 via bolt 178 acts as a focal point 252 for the arc movement of the lever member 240, as depicted in FIGS. 1 and 2 of the drawings. Lever member 240 is made from cast steel or steel alloyed materials.

### Pivot Mounting Bracket 260

The pivot mounting bracket 260 includes, as shown in FIGS. 1 and 2 of the drawings, includes a pivot housing 262 being substantially square-shaped having a first hole opening 264, such that the first hole opening 264 is aligned with the third attachment opening 250 of lever member 240 for pivotally moving lever member 240. The pivot mounting bracket 260 also includes a plurality of mounting openings 266 arranged in an L-shaped configuration being used for mounting and attaching the pivot mounting bracket 260 to the mounting openings 38a to 38e of the main frame housing 20, respectively, via bolts 178. The pivot mounting bracket 260 is made from tooled steel or alloyed steel materials. The pivot mounting bracket 260 is used holding the second attachment end 246 of lever member 240, as well as acts as a focal point 252 in the operational movement of lever member 240.

### Slide Member Assembly 280

The slide member assembly 280, as shown in FIGS. 1, 2, 6 and 7 of the drawings, includes a main slide section 282 having an attachment member section 310 being integrally connected to the main slide section 282, an attachment slide section 320, first and second gib members 350 and 370 and first and second gib ball bearing members 360 and 380. The slide member assembly 280 is used for holding the 90° power transfer shifter in position, as well as for providing the lateral movement in shifting the center drive hub 70 in a forward movement in order to initiate forward thrust of device 10 or in shifting the center drive hub 70 in a reverse movement in order to initiate a reverse thrust of device 10.

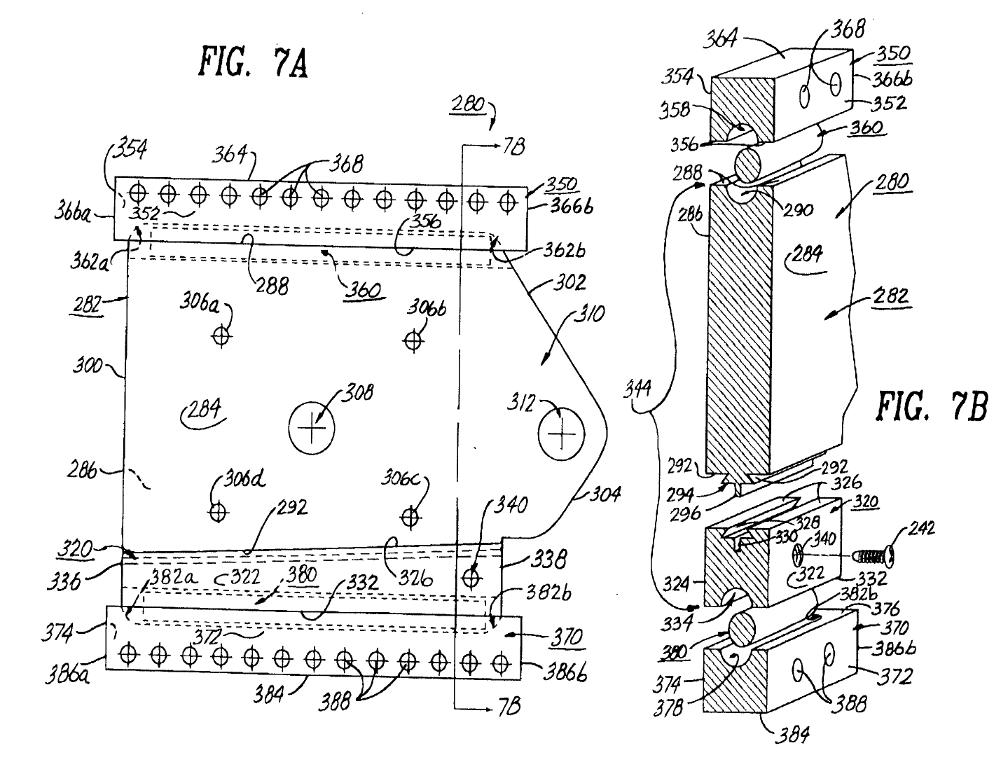

The main slide section 282 being substantially rectangularly-shaped includes an upper top wall surface 284, a bottom wall surface 286, a first side wall surface 288 having a semicircular grooved channel 290 therein for receiving the first gib ball bearing member 360 therein, a second angled side wall surface 292 having a dove-tailed tab member 294 with an extending rectangular tab or fin member 296 thereon, and third, fourth and fifth side wall surfaces 300, 302 and 304. Extending rectangular tab or fin member 296 includes a slotted channel 298 therein for receiving a bolt 178 therethrough, as depicted in FIG. 7 of the drawings.

The main slide section 282 further includes a plurality of mounting openings 306a to 306b for mounting and attaching the 90° power transfer shifter 400 to the upper wall surface 284 of the main slide section 282, and a first hole opening 308 for receiving the vertical shifter shaft 414 of the 90° power transfer shifter 400 therethrough. The attachment member section 310 includes a second hole opening 312 for aligning with the second attachment openings 238 of the second clevis pin 230 being connected via bolt 178.

The attachment slide section 320 being substantially rectangularly-shaped includes an upper top wall surface 322, a bottom wall surface 324, a first angled inner side wall surface 326 having a dove-tailed grooved channel 328 with a centered slotted channel 330 therein, a second outer side wall surface 332 having a semi-circular grooved channel 334 therein for receiving a second gib ball bearing member 380 therein, and end wall surfaces 336 and 338. The attachment slide section 320 further includes a threaded attachment opening 340 for receiving a machine screw 342 for adjusting the attachment main slide section 282 to an appropriate position.

In joining the main slide section 282 to the attachment slide section 320 to form the assembled slide member 344, the dove-tailed grooved channel 328 having the centered slotted channel 330 of attachment slide section 320 is mated and connected with the extending rectangular tab or fin member 296 of the dove-tailed tab member 294 of the main slide section 282, respectively, as depicted in FIG. 7 of the drawings.

The first gib member 350 includes an upper top wall surface 352, a bottom wall surface 354, an inner side wall surface 356 having a semi-circular groove channel 358 therein, being centrally positioned on the inner side wall surface 356, and is used for receiving a portion of the first gib ball bearing member 360 therein. The inner side wall surface 356 includes a pair of retaining sections 362a and 362b for retaining the first gib ball bearing member 360 within the grooved channel 358. The first gib member 350 further includes an outer side wall surface 364, end wall surface 366a and 366b and a plurality of mounting openings 368 for attaching the first gib member 350 to the plurality of mounting openings 170 on the outer cover wall surface 162 of top cover 160, as depicted in FIG. 1 of the drawings.

The second gib member 370 includes an upper top wall surface 372, a bottom wall surface 374, an inner side wall surface 376 having a semi-circular grooved channel 378 therein, being centrally positioned on the inner side wall surface 376, and is used for receiving a portion of the second gib ball bearing member 380 therein. The inner side wall surface 376 includes a pair of retaining sections 382a and 382b for retaining the second gib ball bearing member 380 within the grooved channel 378. The second gib member 370 further includes an outer side wall surface 384, end wall surfaces 386a and 386b, and a plurality of mounting openings 388 for attaching the second gib member 370 to the plurality of mounting openings 172 on the outer cover wall surface 162 of top cover 160, as depicted in FIG. 1 of the drawings.

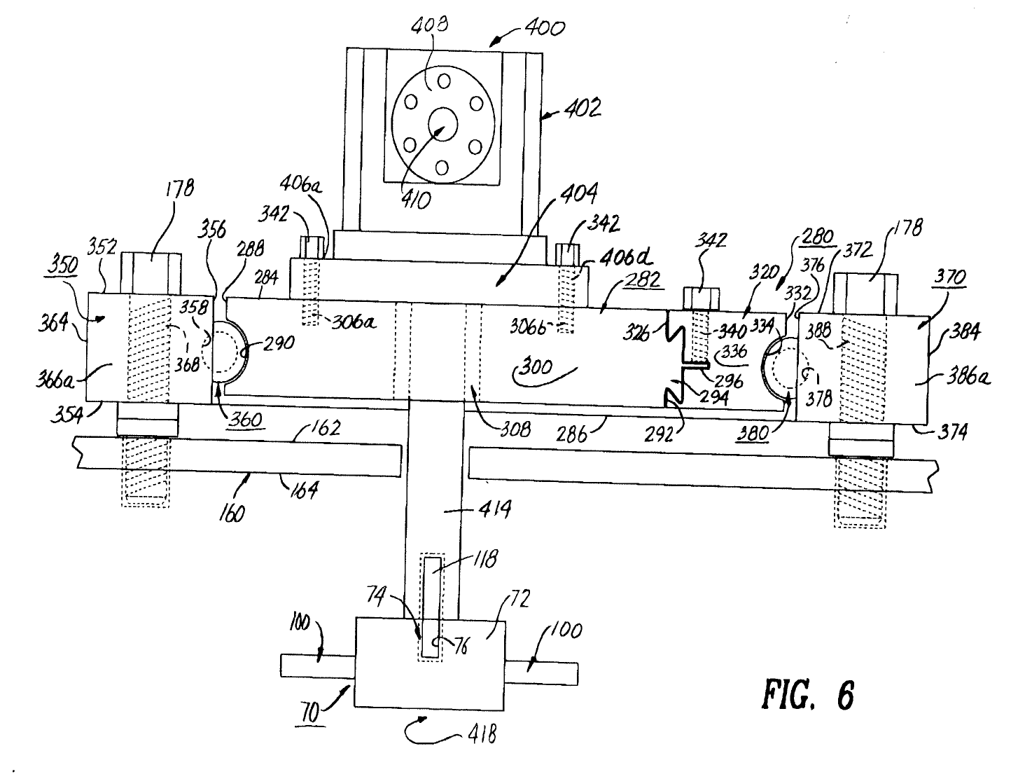

Each of the gib members 350 and 370 are made from tooled steel or alloyed steel materials. Each of the gib members 350 and 370 hold in place each of the gib ball bearing members 360 and 380, respectively, as well as the assembled and formed slide member 344 in a proper and aligned positioned relative to the top cover 160 of device 10, as shown in FIGS. 1 and 6 of the drawings.

Additionally, slide member assembly 280 includes an electronic calibrator device 390 for detecting the true center of the slide member assembly 280 in relationship to the main frame 20. The electronic calibrator device 390 is attached to the outer cover wall surface 162 of top cover 160 and to the side wall 364 of the first gib member 350 of the slide member assembly 280, as shown in FIG. 1 of the drawings.

### 90° Power Transfer Shifter 400

The 90° power transfer shifter 400, as shown in FIGS. 1, 2, 6, 7 and 10 of the drawings, includes a shifter housing/casing 403 being connected to an attachment frame 404 having a plurality of mounting openings 406a to 406d for mounting and aligning with the mounting openings 306a to 306d located on the upper top wall surface 284 of the main slide section 282. The 90° power transfer shifter 400 further includes a first angle changer element 408 having a first horizontal shifter shaft 410 attached thereto and includes a second angle changer element 412 having a second vertical shifter shaft 414 attached thereto. The second vertical shifter shaft 414 includes a keyway channel 416 for use with key channel 76 of shaft opening 74 of center drive hub 70 via the keyway bar 118 in order to lock the vertical shifter shaft 414 to that of the shaft opening 74 of the center drive hub 70. Vertical shifter shaft 414 of power transfer shifter 400 enables the center drive hub 70 to turn. The 90° power transfer shifter 400 is used for transforming the vertical circular motion 494 from the electric motor device 480 to become horizontal circular motion 418 which enables the center drive hub 70 to turn in either clockwise or counter clockwise movement.

### Ball Bearing Spline Device 420

The ball bearing spline device 420, as shown in FIGS. 1,2 and 10, includes an outer race housing 422 having ball bearings 424 therein, and an inner race shaft member 426. The inner race shaft member 426 includes a first end 428 having a power transfer adapter 430 therein, being detachably connected to the first horizontal shifter shaft 410 of the 90° power transfer shifter 400 via a set screw 436, and a second end 432 having an electric clutch adapter 434 thereon, being detachably connected to the first shaft member 452 of the electric clutch motor device 440 via a set screw 436. Power transfer adapter 430 includes a set screw opening 431 for receiving a set screw 436 for connecting adapter 430 to horizontal shifter shaft 410. Electric clutch adapter 434 includes a set screw opening 435 for receiving a set screw 436 for connecting adapter 434 to first shaft member 452 of the electric clutch motor 440. The ball bearing spline device 420 is used for giving friction-free linear motion fro the electric clutch motor device 440 while simultaneously transmitting torsional loads to the horizontal shifter shaft 410 of the 90° power transfer shifter 400.

### Electric Clutch Device 440

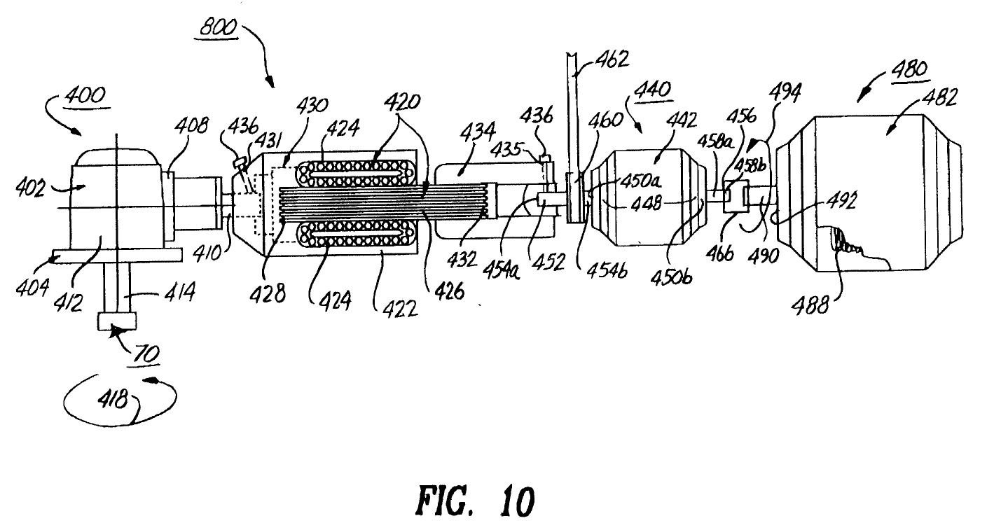

The electric clutch device 440, as shown in FIGS. 1, 2 and 10 of the drawings, includes a clutch casing 442, a clutch frame 444 having a plurality of mounting openings 446 for mounting and attaching to the mounting openings 42a to 42d of the main frame housing 20 via bolts 178, and a clutch engager member 448 therein having an inner end 450a and outer end 450b. The electric clutch device 440 also includes a first shaft member 452, being received and connected with the electric clutch adapter 434 of the ball bearing spline device 420 at one end 454a of shaft member 452, and at the other end 454b of shaft member 452 being connected with the inner end 450a of the clutch engager member 448. Also, at the other end 454b of shaft member 452 additionally includes a drive pulley 460 and belt 462 for operating the air pump device 500. The electric clutch device 440 further includes a second shaft member 456, being connected at one end 458a of the shaft member 456 to the outer end 450b of the clutch engager member 448; and the other end 458b of the shaft member 456 is detachably connected to the electric motor connector 466. The electric motor connector 466 connects the second shaft member 456 of the electric clutch device 440 to the electric motor 5 shaft 490 of the electric motor device 480, as shown in FIG. 10 of the drawings.

Additionally, the electric clutch device 440 includes a power conduit 464 for use within the electrical and hydraulic pressure system 600, and cooling system 700, as shown in FIGS. 8 and 9 of the drawings. The electric clutch device 440 is used for operating the air pump device 500 when the cooling system 700 is in an operational (“ON” mode) mode, for cooling the centrifugal force retaining ring 60.

### Electric Motor Device 480

The electric motor device 480, as shown in FIGS. 1, 2, 8, 9 and 10 of the drawings, includes a motor casing 482, a motor frame 484 having a plurality of mounting openings 486 for mounting and attaching to the mounting openings 40a to 40d of the main frame housing 20 via bolts 178, and an electric motor 488 therein having an electric motor shaft 490 thereon. The electric motor shaft 490 is attached to the inner end 492 of the electric motor 488, and provides vertical circular motion 494 when the electric motor device 480 is in an operational mode. The electric motor device 480 is used for providing the transformable motion along the power train layout 800 for device 10, as shown in FIG. 10 of the drawings.

### Air Pump Device 500

The air pump device 500, as shown in FIGS. 1, 2 and 9 of the drawings, includes an air pump housing 502, an air pump frame 504 having a plurality of mounting openings 506 for mounting and attaching to the mounting openings 44a to 44d of the main frame housing 20 via bolts 178 and an air pump member 508 therein. Air pump member 508 includes an air pump drive shaft 509 having a idler pulley 511 thereon. Idler pulley 511 is attached to drive belt 462 from the drive pulley 460 of the electric clutch device 440. The air pump device 500 further includes an air intake pipe 510 having an air filter 512 thereon. The air intake pipe 510 is connected to the air pump member 508. The air pump device 500 also includes an air exhaust pipe 514, being connected to the air pump member 508. The air exhaust pipe 514 includes an air exhaust line 516 connected at the first end 518a to the air exhaust pipe 514 and at the second end 518b to the air intake port 526 of the air molecule splitter member 520.

The air molecule splitter member 520, as shown in FIG. 9 of the drawings, includes an air molecule splitter housing 522, an air molecule splitter element 524 within the splitter housing 522, an ambient air intake port 526, a cold air outlet port 528 having a cold air outlet line 530 thereon being connected at the first end 532a of air outer line 530 and the second end 532b of air outlet line 530 being attached to the air connector element 534. Air connector element 534 is threadedly attached to the first cold air intake opening 52a of the air inlet channel 50 on the main frame housing 20. The air molecule splitter housing 522 includes a second shaft member 456, being connected at one end 458a of the shaft member 456 to the outer end 450b of the clutch engager member 448; and the other end 458b of the shaft member 456 is detachably connected to the electric motor connector 466. The electric motor connector 466 connects the second shaft member 456 of the electric clutch device 440 to the electric motor shaft 490 of the electric motor device 480, as shown in FIG. 10 of the drawings. Additionally, the electric clutch device 440 includes a power conduit 464 for use within the electrical and hydraulic pressure system 600, and cooling system 700, as shown in FIGS. 8 and 9 of the drawings. The electric clutch device 440 is used for operating the air pump device 500 when the cooling system 700 is in an operational (“ON” mode) mode, for cooling the centrifugal force retaining ring 60.

### Electric Motor Device 480

The electric motor device 480, as shown in FIGS. 1,2, 8, 9 and 10 of the drawings, includes a motor casing 482, a motor frame 484 having a plurality of mounting openings 486 for mounting and attaching to the mounting openings 40a to 40d of the main frame housing 20 via bolts 178, and an electric motor 488 therein having an electric motor shaft 490 thereon. The electric motor shaft 490 is attached to the inner end 492 of the electric motor 488, and provides vertical circular motion 494 when the electric motor device 480 is in an operational mode. The electric motor device 480 is used for providing the transformable motion along the power train layout 800 for device 10, as shown in FIG. 10 of the drawings.

### Air Pump Device 500

The air pump device 500, as shown in FIGS. 1, 2 and 9 of the drawings, includes an air pump housing 502, an air pump frame 504 having a plurality of mounting openings 506 for mounting and attaching to the mounting openings 44a to 44d of the main frame housing 20 via bolts 178 and an air pump member 508 therein. Air pump member 508 includes an air pump drive shaft 509 having a idler pulley 511 thereon. Idler pulley 511 is attached to drive belt 462 from the drive pulley 460 of the electric clutch device 440. The air pump device 500 further includes an air intake pipe 510 having an air filter 512 thereon. The air intake pipe 510 is connected to the air pump member 508. The air pump device 500 also includes an air exhaust pipe 514, being connected to the air pump member 508. The air exhaust pipe 514 includes an air exhaust line 516 connected at the first end 518a to the air exhaust pipe 514 and at the second end 518b to the air intake port 526 of the air molecule splitter member 520.

The air molecule splitter member 520, as shown in FIG. 9 of the drawings, includes an air molecule splitter housing 522, an air molecule splitter element 524 within the splitter housing 522, an ambient air intake port 526, a cold air outlet port 528 having a cold air outlet line 530 thereon being connected at the first end 532a of air outer line 530 and the second end 532b of air outlet line 530 being attached to the air connector element 534. Air connector element 534 is threadedly attached to the first cold air intake opening 52a of the air inlet channel 50 on the main frame housing 20. The air molecule splitter housing 522 includes a warm air outlet port 536 having a warm air outlet line 538 thereon.

When in an operational mode, ambient air 540 is ingested through air filter 512 and air pump member 508, respectively, where then the ambient air 540 is exhausted to the ambient air intake port 526 via the air exhaust line 516. The ambient air 540 is then processed within the air molecule splitter element 524 to produce a warm air stream 542 and a cold air stream 544. The warm air stream 542 is exhausted and vented through the warm air outlet port 536 and warm air outlet line 538, respectively. The cold air stream 544 is exhausted through the cold air outlet port 528 and cold air outlet line 530, respectively, where then the cold air 544 is received within the cold air inlet channel 50. The cold air 544 is then dispersed within the cooling core section 64c of the centrifugal force retaining ring 60. The cold air stream 544 maintains a proper temperature for the retaining ring 60 when in an operational mode, as the weight roller assemblies 120A to 120D are spinning within the retaining ring 60, as shown in FIG. 4 of the drawings. During the winter, in cold temperatures, the hot and warm air produced by the air pump device 500 and by the rotating weight roller member assemblies 120A to 120D can be used to heat the main frame 20 of the centrifugal forge generator and converter device 10, of the present invention.

### Electrical and Hydraulic System 600

The electrical and hydraulic system 600, as shown in FIG. 8, includes an electronic control unit (CPU) 602 for electronically controlling the electronic acceleration pedal 16, the electronic brake pedal 18, the fuel cell 604, the battery (12 volt) 606, a power on switch 608, the main drive electric motor device 480, the hydraulic pump electric motor device 610, and the control solenoid valve 620 via electrical lines 630, 632, 634, 636, 638, 640 and 642, respectively. The control solenoid valve 620 is used to control the intake of hydraulic fluid 626 to the two-way hydraulic cylinder device 200 in which to activate its hydraulic piston cylinder member 202. The electrical and hydraulic system 600 further includes the two-way hydraulic cylinder device 200 for hydraulically controlling via the control solenoid valve 620 the lever member 240 and the slide member assembly 280 (as previously discussed), and an hydraulic pump 622 having an hydraulic fluid reservoir 624 connected thereto for holding hydraulic fluid 626 therein. The electrical and hydraulic system 600 also includes hydraulic fluid inlet lines 630 and 632 and hydraulic fluid outlet lines 634 and 636 for transferring the hydraulic fluid 626 to the two-way hydraulic cylinder device 200 in operating its hydraulic piston cylinder member 202.

### Cooling System 700

The cooling system 700, as shown in FIG. 9 of the drawings, includes a thermostat control unit 702, the electric clutch device 440, the electric motor device 480, the air pump device 500 having an air molecule splitter member 520 thereon, the air inlet channel 50, the air exhaust channel 54 and the cooling core opening 64c in which cool the centrifugal force retaining ring from over heating when device 10 is in operational use thereof. The thermostat control unit 702 is electrically connected to the electronic control unit (CPU) 620 via electrical line 704 for electronic activation of the thermostat control unit 702. The thermostat control unit 702 includes a power conduit electrical line 464 for electrically connecting to the electric clutch device 440 and a pair of thermocouples 706 and 708 for measuring the temperatures (T₁ and T₂) of the metal surface 22a at the air inlet channel 50 and the metal surface 22b at the air exhaust channel 54, respectively. Each of the thermocouples 706 and 708 are attached to the metal surfaces 22a and 22b of the main frame 20 and are adjacent to each of the cold air intake opening 52b of air intake channel 50 and the cold air exhaust opening 56b of air exhaust channel 54, respectively.

In an operational mode, the weight roller assemblies 120A to 120D cause a heat build-up within the retaining ring 60, such that the thermostat control unit 702 measures the temperatures T₁ and T₂ at the air inlet and air exhaust channels 50 and 54 via the thermocouples 706 and 708, respectively. When the temperatures T₁ and T₂ reach a predetermined temperature (Tₚ), the thermostat control unit 702 activates the electric clutch device 440 which in turn activates the air pump device 500 to turn-on. The air pump device 500 then produces a cold air stream 544 via the air molecule splitter member 520. The cold air stream 544 is then received within the cooling core opening 64c in which to cool the centrifugal force retaining ring 60 from over heating. When the retaining ring 60 has been sufficiently cooled or when device 10 is a non-operational mode, the thermocouples 706 and 708 will sense the drop of temperature within the cooling core opening 64c, which will in turn electronically switch off the electric clutch device 440 via the thermostat control unit 702. Thus, turning off the air pump device 500 and air molecular splitter member 520, simultaneously, stopping the flow of the cold air stream 544 to the retaining ring 60, as depicted in FIG. 8 of the drawings.

### Power Train Layout 800

The power train layout 800 for device 10, as shown in FIG. 10 of the drawings, includes the main drive electric motor device 480, the electric clutch device 440, the ball bearing spline device 420 and the 90° power transfer shifter 400. The main drive electric motor device 480 is connected to the electric clutch device 440 via the electric motor connector 466. The electric clutch device 440 is connected to the ball bearing spine device 420 via the electric clutch adapter 434. The ball bearing spline device 420 is connected to the 90° power transfer shifter 400 via the power transfer adapter 430. The main drive electric motor device 480 provides the lateral circular motion 494 to the 90° power transfer shifter 400 which in turn transforms the lateral circular motion 494 to that of longitudinal circular motion 418, as shown in FIG. 10 of the drawings. The longitudinal circular motion 418 via the vertical shaft member 414 moves the weight roller assemblies 120A to 120D to turn within the retaining ring 60 which then produces the momentum/thrust to move the vehicle 10 in a forward or reverse direction.

### OPERATION OF THE INVENTION

In operation, the centrifugal force generator and converter device 10, as shown in FIGS. 1, 4, 6, and 8 of the drawings, is activated via the power on switch 608 which then powers the electronic control unit (CPU) 602. When the user depresses the electronic acceleration pedal 16, it simultaneously activates both the control solenoid valve 620 and the main drive electric motor device 480. The control solenoid valve 620 then activates the two-way hydraulic cylinder device 200 which in turn then moves the lever member 240 and slide member assembly 280 in a lateral motion/movement 210 (⇄). When the hydraulic cylinder 200 reaches an internal pressure of 3000 psig, an electronic signal is sent to the main drive electric motor device 480 which is then turned on, which in turn the rotates the electric motor shaft 490. As depicted in the power train layout 800, the electric motor device 480 produces a lateral circular motion 494 which is then transformed to a longitudinal circular motion 418 by the rotation of the vertical shaft 414 by the 90° power transfer shifter 400.

This action in turn rotates the center drive hub 70 which then rotates the plurality of weight roller assemblies 120A to 120D. Since the weight roller assemblies 120A to 120D had been shifted (laterally moved) by the combination of the hydraulic cylinder 200, the lever member 240, and slide member assembly 280, this results in the device 10 producing a forward or reverse thrust of force. Depending upon the electric motor speed, as shown in FIG. 11 of the drawings, various pounds of force are produced. For example, at ¼ speed (437.5 rpm) produces 1582 pounds of force, at ½ speed (875 rpm) produces 6,554 pounds of force, at ¾ speed (1312.5 rpm) produces 11,750 pounds of force, at full speed (1750 rpm) produces 26,214 pounds of force, and at 1¼ speed (2,187.5 rpm) produces 40,960 pounds of force.

When the user wants to stop the moving vehicle 12, the user steps on the electronic braking pedal which then activates the hydraulic cylinder 200 to move the lever member 240 and the slide member assembly 280 in a lateral motion 210 (opposite of the initial movement to go forward) for reversing the thrust of device 10. This in turn moves the plurality of the weight roller assemblies 120A to 120D in the opposite direction on the centrifugal force retaining ring 60 which produces a reversing thrust to slow or stop the moving vehicle 12. Also, the brake pedal 18 is connected to a conventional braking system (not shown) for instantaneously stopping the moving vehicle 12 on a roadway.

### ADVANTAGES OF THE PRESENT INVENTION

Accordingly, an advantage of the present invention is that it provides for an improved centrifugal force generator and converter having means for converting rotational (centrifugal) energy into a unidirectional (translational) energy in order to transfer the thrust or momentum to move a vehicle in a forward direction or in a reverse direction.

Another advantage of the present invention is that it provides for a centrifugal force generator and converter for moving a vehicle in a forward direction or in a reverse (opposite) direction having no braking devices needed in order to stop the momentum of the vehicle while in motion.

Another advantage of the present invention is that it provides for a centrifugal force generator and converter that is made of durable construction having a minimum of moving parts therein and being relatively compact in size and does not require complex gearing mechanisms.

Another advantage of the present invention is that it provides for a centrifugal force generator and converter that generates a unidirectional force that may be changed so that the force is exterted in the desired direction and is easily controlled by the driver/user.

Another advantage of the present invention is that it provides for a centrifugal force generator and converter that uses a rotatable drive wheel having a series of weighted rollers about its periphery within a strengthen housing for generating rotational energy to translational energy in which to provide thrust to move a vehicle via the centrifugal force of the rotatable drive wheel.

Another advantage of the present invention is that it provides for a centrifugal force generator and converter that is used in conjunction with an internal combustion engine, an electric motor, or other types of engines for moving a vehicle.

Another advantage of the present invention is that it provides for a centrifugal force generator and converter that exerts a thrust of 26,200 lbs. at full speed.

Another advantage of the present invention is that it provides for a centrifugal force generator and converter that uses a hydraulic system to return the rotatable drive wheel to a neutral position within the generator/converter housing.

A further advantage of the present invention is that it provides for a centrifugal force generator and converter that is cost efficient and economical in operation having low/minimal maintenance problems when in use.

A still further advantage of the present invention is that it provides for a centrifugal force generator and converter that can be mass produced in an automated and economical manner and is readily affordable by the user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A centrifugal force generator and converter device for increasing or decreasing the thrust of a moving vehicle, in either of an acceleration mode or in a deceleration mode, comprising:
a) an engine housing for receiving a thrust assembly including a retaining ring having an inner perimeter rim surface thereon; a plurality of weight roller assemblies; and a center drive hub assembly for rotating and driving said plurality of weight roller assemblies relative to said inner perimeter rim surface of said retaining ring for creating a centrifugal force;
b) power transfer shifter means having a horizontal shaft and a vertical shaft;
c) a power drive train for rotating said horizontal shaft in a first direction, and rotating said vertical shaft in a second direction through said power transfer shifter means;
d) said vertical shaft connected to and for moving said center drive hub assembly in a forward or reverse direction;
e) a slide assembly connected to said power transfer shifter, and to said engine housing; and said slide assembly being movable relative to said engine housing; and
f) an hydraulic system and a linkage assembly connected to said slide assembly for moving said slide assembly, said vertical shaft, and said thrust assembly in a forward or reverse direction to build up centrifugal force in said engine housing to move the vehicle in a forward or reverse direction.

2. A centrifugal force generator and converter device in accordance with claim 1, further including an electrical system for electrically operating said centrifugal force generator and converter device.

3. A centrifugal force generator and converter device in accordance with claim 2, wherein said electrical system includes an electronic control unit, one or more batteries and a power-on switch for electronically controlling said power drive train and said hydraulic system.

4. A centrifugal force generator and converter device in accordance with claim 3, wherein said one or more batteries include a 12 volt battery.

5. A centrifugal force generator and converter device in accordance with claim 1, wherein said power drive train includes an electrical motor having connecting means.

6. A centrifugal force generator and converter device in accordance with claim 1, wherein said connecting means includes a ball bearing spline device having adapters thereon for connecting s aid electrical motor to said power transfer shifter.

7. A centrifugal force generator and converter device in accordance with claim 1, wherein said hydraulic system includes a two-way hydraulic cylinder having a piston cylinder, a control solenoid valve, a hydraulic pump, a hydraulic reservoir having hydraulic fluid therein and a plurality of hydraulic fluid lines attached thereto for hydraulically operating said piston cylinder of said hydraulic cylinder for moving said linkage assembly in a forward or reverse direction.

8. A centrifugal force generator and converter device in accordance with claim 1, wherein said engine housing include an air inlet channel and an air exhaust channel.

9. A centrifugal force generator and converter device in accordance with claim 1, wherein said retaining ring includes a cooling core opening for receiving cold air therein.

10. A centrifugal force generator and converter device in accordance with claim 1, further including a cooling system for keeping said centrifugal force generator and converter device from heating up.

11. A centrifugal force generator and converter device in accordance with claim 10, wherein said cooling system includes a thermostat control unit, an electric clutch device, said electric motor and an air pump device having an air molecule splitter member attached thereto for producing a cold air stream.

12. A centrifugal force generator and converter device in accordance with claim 11, wherein said thermostat control unit includes a first thermocouple for measuring the temperature of the metal surface of said air inlet channel and a second thermocouple for measuring of the metal surface of said air exhaust channel.

13. A centrifugal force generator and converter device in accordance with claim 1, wherein said plurality of weight roller assemblies each include a weight roller member having a cavity section therein for receiving a weight roller pin therein, each of said weight roller pins in contact with said inner perimeter rim of said retaining ring for creating a centrifugal force.

14. A centrifugal force generator and converter device in accordance with claim 13, wherein each of said weight roller members include a pair of openings for receiving weight roller pins therein; said weight roller pins having a slide bearing thereon; said weight roller pins for connecting each of said weight roller members to said center drive hub assembly for enabling each of said weight roller members to forwardly shift at least ¼ of an inch in order to create the centrifugal force within said thrust assembly in which to move the vehicle in a forward or reverse direction.

15. A centrifugal force generator and converter device in accordance with claim 1, wherein said slide assembly includes a main slide section having an attachment member section, an attachment slide section being slidably connected to said main slide section for forming an assembled slide member; said assembled slide member for slidably moving relative to said engine housing.

16. A centrifugal force generator and converter device in accordance with claim 1, wherein said slide assembly further includes a first and second gib ball bearings and first and second gib members for allowing the movement of said assembled slide member in a forward or reverse direction.

17. A centrifugal force generator and converter device in accordance with claim 1, further includes a top cover and a bottom cover for covering and protecting said engine housing from dirt, dust and/or debris.

18. A centrifugal force generator and converter device in accordance with claim 17, wherein said first and second gib members mounted on said top cover for allowing said assembled slide member to move relative to said top cover and said engine housing in a forward or reverse direction.

19. A centrifugal force generator and converter device in accordance with claim 1, wherein said linkage assembly includes first and second clevis pins being detachably connected at each end of a lever member, and a pivot mounting bracket connected to said one end of said lever member for providing a focal point for the operational movement of said lever member.

20. A centrifugal force generator and converter device in accordance with claim 19, wherein said attachment member of said assembled slide member is connected to said second clevis pin of said linkage assembly for allowing said assembled slide member to move in a forward or reverse direction.
